(19) United States
(12) Patent Application Publication
(10) Pub. No.: US 2022/0222697 A1
(43) Pub. Date: Jul. 14, 2022

(54) SYSTEM AND METHOD FOR INCREASING SOCIAL PHONE CALLS BETWEEN THE YOUNG AND ELDERLY

(71) Applicant: Sam D. Balabon, Austin, TX (US)

(72) Inventor: Sam D. Balabon, Austin, TX (US)

(21) Appl. No.: 17/146,952

(22) Filed: Jan. 12, 2021

(51) Int. Cl. G06Q 30/02; G06Q 50/32; H04M 3/22

(52) U.S. Cl. CPC G06Q 30/0208; H04M 2250/60; H04M 3/2218; G06Q 50/32

(57) ABSTRACT

The invention allows people to impose their will on how their friends/family members socialize with one another. Incentives can vary from cash to simply challenging one party to do the right thing. For example, a middle-aged mother wants her daughter to call her grandmother more often. The invention provides a new way the mother can request, incentivize, and validate the phone calls her daughter makes to her grandmother.

### BACKGROUND OF INVENTION

Many of our elderly describe themselves as being lonely. With research indicating that loneliness can be a crucial factor in developing Alzheimer's disease—apparently, older people who report that they experience severe loneliness are twice as likely to develop the condition—it's clear that this is a problem which urgently needs to be addressed.

Our society has changed dramatically over the past few decades, and families no longer spend as much time together as they used to. The global society has made it easier than ever to communicate with people on the other side of the world—but we tend to forget about the older generation, many of whom are unfamiliar with digital technology.

Yet as people age, their social networks often fall apart, leaving them alone with only their television, radio, and pets to keep them company. A fear of falling over may prevent them from getting out and about on their own and if they are unable to drive, they can quickly start to feel as though they are prisoners in their own home. Having someone to talk to and interact with can literally make a lonely older person's day.

With the advent of social media and all the evolutions in communication it has brought about, in many respects people are more connected to one another today than they have been in all of human history. Often overlooked, however, are the adverse effects these technological developments have had on the *depth* of interpersonal communication and the degree to which this lack of genuine socialization has left many with a sense of profound emotional detachment from their fellow man. Compounded by the ramifications of increased workforce participation, more demanding hours (with many people now working more than one job), and a constant barrage of media-imposed distractions—the world, in an age of unprecedented interconnectivity, paradoxically finds itself in the midst of an epidemic of loneliness.

Although few in the developed world have been spared the consequences of these increasingly inorganic relational dynamics, it is the emotional well-being of our elderly population that finds itself in the greatest jeopardy. While the largely more lucid and tech-savvy younger generations still find themselves able to socialize with their friends and families at their convenience, the older and more vulnerable among us find contemporary outlets for socialization inaccessible and are thus left by the wayside in many respects. This problem is twofold, as discrepancy in networking capabilities yields frayed inter-generational bonds—particularly between the oldest and youngest generations. With this process, the young and the old have been rendered insulated groups within themselves (i.e., the technological realities that have shaped the milieu of Generation Z are irreconcilably foreign to the ones which defined the Silent Generation, whose natural reliance on antiquated technology has alienated them from a world now built around mobile apps and web browsing). This comes at a time when the elderly's last significant outlet for intimate, meaningful communication with their loved ones—physical interaction—has been severely hindered by Covid-19.

In the pursuit to solve this social problem, companion and wellness calls have been made available. These calls are made by the employees of the companies that provide these services. They typically call the senior citizen on a regular basis to see if they are ok or to provide companionship. These workers are not members of the senior citizen's family. There are multiple companies that provide these services:

Wellness Call Companies:
https://www.commonwisecare.com/careers/
https://www.littlebrothersmn.org/elder-programs/
https://companionmatters.com/once-a-week-companion-call/
https://sageminder.com/Caregiving/CaregivingBasics/SeniorCall.aspx

There are also paid virtual friendship services that charge by the hour to socialize with paying customers such as:
https://www.logicaldollar.com/get-paid-virtual-friend/

The drawback to this trend is these services are conducted by non-family members, so there is no pre-existing love between the caregiver and the senior citizen. For some seniors, only a call from a loved one contributes to their feeling of wellbeing.

### SUMMARY OF INVENTION

The main theme of the invention is to provide a new tool for society that allows the middle generation to incentivize the younger generation to communicate more to the older generation. More broadly, this allows people to pay people they know to communicate in a particular manner with other people they know.

This is generally in the best interests of all three people concerned. Party A is happy because Party B and Party C are helped. Party B is happy because they get compensated by Party A and feel good about helping Party C. Party C is happy because they are able to spend more time with their loved ones.

The most efficient use of the invention requires pre-established personal non-business relationships among Party A, Party B, and Party C.

The basic process begins with Party A suggesting a task to Party B to perform for Party A as a personal favor or for something of monetary value (e.g., a gift card or cash). The task describes a specific mode of social or business interaction between Party B and Party C, which Party B must abide by. The task is communicated to Party B. If Party B agrees to complete the task, Party A is notified. Party B then communicates to Party C. Party A may be notified that the communication occurred, which results in the internet application/website releasing any promised financial benefit to Party B.

### DETAILED DESCRIPTION OF THE INVENTION

There are many embodiments of the invention. Party B may be requested to call Party C in accordance with a specific time period such as hourly, daily, weekly or monthly. For example, Party A may request Party B call Party C each month for the next six months. The computer application/internet website may require a time period to elapse between the calls made between Party B and Party C in order to collect an additional benefit/payment from Party A.

Party A may request that both Party B and Party C communicate with each other in a specific way. Other types of requests could involve Party B advising Party C on a number of different topics. Party A may want to teach Party C something through Party B.

Technology can be used to authenticate if Party B communicated with Party C in the manner that Party A prescribed or vice versa. Multiple tools could be used to validate communications between Party B and Party C such as monitoring, voice recognition software, and artificial intelligence. This assures Party A whether the discipline imposed on Party B actually occurred. A minimum time between each communication between Party A and Party B call may be imposed by Party A in order for Party B to be compensated. Essentially, Party A manufactures rules of conduct that Party B must abide by in their communications with Party C. Such conditions can be imposed on Party B in order to receive payment from Party A.

During each call, voice recognition software could be used to validate the parties on the call and track the time both parties engaged on the call. Artificial intelligence listening in on the conversations could validate whether the types of discussions that take place are permissible in accordance with Party A's guidelines.

The computer application/internet site could have a selection of disciplines/tasks that Party A can request that Party B conduct with Party C; essentially, a script that Party A wants Party B to use when communicating with Party C. The mode of communication may also differ between Party B and Party C. Video, text, or email could be used as a mode of communication between Party B and Party C rather than voice only.

Simultaneously, Party A may request Party B and Party C to communicate with each other in a specific way over an extended period of time to achieve a specific purpose. For example, Party A, acting in the role of a matchmaker, wants Party B and Party C to get together as a couple. Party A requests that Party B and Party C talk daily on the phone for one hour and each of them will get a $50 Amazon gift card for each call made. This way, Party A is able to incentivize Party B and Party C to socially develop a relationship between each other—which results in using the said invention to impose the will of Party A onto Party B and Party C.

### BRIEF DESCRIPTION OF DRAWINGS

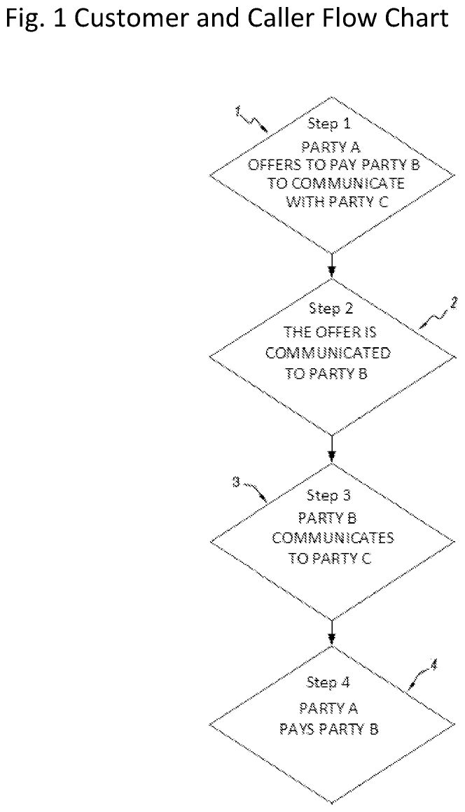

FIG. 1 illustrates the basic steps to be performed on a website/computer application.
1. Once a customer (Party A) creates their profile, they are able to create a proposal to be communicated to their friend/family member. The proposal contains an offer from Party A to Party B to communicate with Party C. The proposal may contain an incentive and a topic that Party A wants Party B to discuss with Party C. The topic of discussion generally consists of a younger family member (Party B) discussing their lives with an older family member (Party C). Once a proposal is developed by Party A, it is communicated to Party B.
2. Once Party B accepts the proposal from Party A, Party B calls Party C.
3. Once validation of the communication is made, whether by using software or simply Party B reporting communication manually, Party A pays Party B through the website/computer application.

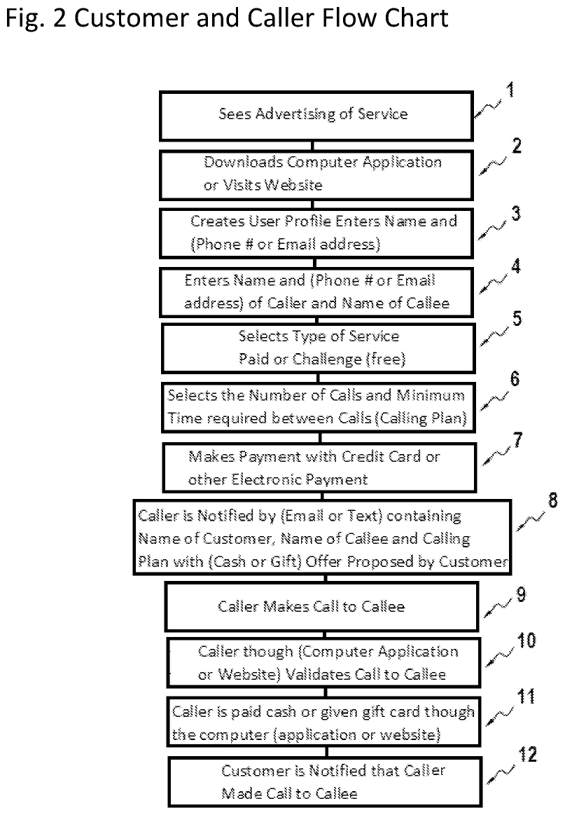

FIG. 2 illustrates more detailed basic steps to be performed on a website/computer application.
1. The customer sees advertising of the service in print or online.
2. The customer then downloads the computer application or visits the website of the service.
3. The customer creates a user profile with her name and phone number or email address.
4. The customer enters the name and phone number or email address of the caller and the name of callee.
5. The customer selects the type of service: paid or challenge (free).
6. The customer selects the number of calls that she wants her loved one to make and the minimum time required between calls (calling plan).
7. The customer makes payment with credit card or other electronic payment method to determine the amount of money, if any, will be paid to their loved one to make calls to their elderly loved one.
8. The caller is notified by an email or a text with the name of customer, the name of the callee, and the calling plan with the cash or gift card offer proposed by the customer.
9. The caller calls the elderly loved one (the callee).
10. The caller validates the call to the callee through the computer application or website.
11. The caller is paid cash or given a gift card though the computer application or website.
12. The customer is notified that the caller called the callee.

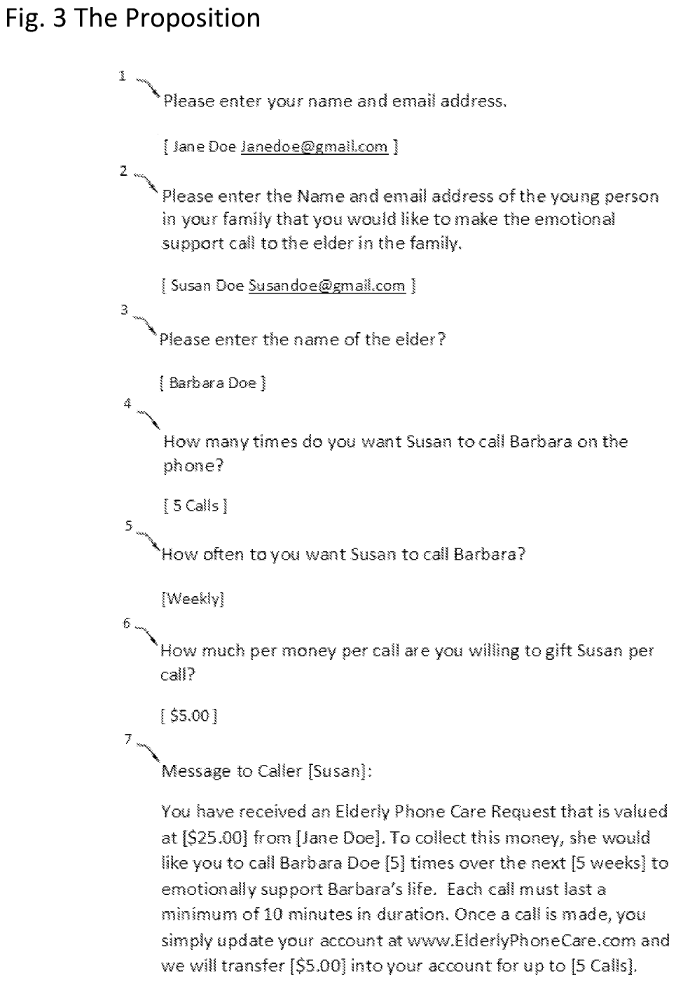

FIG. 3 illustrates a questionnaire that is answered by the customer in order to create the proposal between the customer and the caller and the proposal itself.
1. “Please enter your name and email address.” [Jane Doe Janedoe@gmail.com]
2. “Please enter the name and email address of the young person in your family that you would like to make the emotional support call to the elder in the family.” [Susan Doe Susandoe@gmail.com]
3. “Please enter the name of the elder?” [Barbara Doe]
4. “How many times do you want Susan to call Barbara on the phone?” [5 Calls]
5. “How often do you want Susan to call Barbara?” [Weekly]
6. “How much per money are you willing to gift Susan per call?” [$5.00]
7. Message to Caller [Susan]:
   “You have received an Elderly Phone Care Request that is valued at [$25.00] from [Jane Doe]. To collect this money, she would like you to call Barbara Doe [5] times over the next [5 weeks] to emotionally support Barbara's life. Each call must last a minimum of 10 minutes in duration. Once a call is made, you simply update your account at www.ElderlyPhoneCare.com and we will transfer [$5.00] into your account for up to [5 Calls].”

1-11. (canceled)

12. A computer-implemented method to incentivize socializing communication comprising:
receiving a set of rules for implementation by a party B regarding said communication of said party B with a party C;
receiving a definition of reward given to said Party B, subject to implementation of said rules by said party B; and
validating compliance in implementing said rules by said party B.

13. The method of claim 12, wherein said validation is conditional on approval of said rules by said party B.

14. The method of claim 12 wherein said rules received from a party A.

15. The method of claim 12, comprising notifying said party A regarding said compliance or non-compliance.

16. The method of claim 12, wherein said set of rules comprises minimal communication duration.

17. The method of claim 12, wherein said validating being performed by Artificial Intelligence (AI) analyzing content of said communication.

18. The method of claim 12, wherein said validating comprises utilizing voice recognition to validate the identity of said party B.

19. The method of claim 12, wherein said validating comprises utilizing voice recognition to validate the identity of said party C.

20. The method of claim 12, wherein said reward is a payment.

21. The method of claim 12, wherein said set of rules comprises minimal communication duration.

22. The method of claim 12, wherein said set of rules comprises a permissible time period between said communications.

23. The method of claim 14, comprising verifying that said party B is a family member of at least one of said party A and said party B.

24. The method of claim 23 wherein said verifying selected from the group consisting of voice recognition, user information of said party A, user information of said party B, user information of said party C, and combinations thereof.

25. A computerized apparatus having a processor, said processor being adapted to perform the steps of:
receiving a set of rules for implementation by a party B regarding said communication of party said B with a party C;
receiving a definition of reward given to said Party B, subject to implementation of said rules by said party B; and
validating compliance in implementing said rules by party said B.

26. The apparatus of claim 25 wherein said rules received from a party A.

27. The apparatus of claim 26, comprising verifying that said party B is a family member of at least one of said party A and said party B.

28. The apparatus of claim 27 wherein said verifying selected from the group consisting of voice recognition, user information of said party A, user information of said party B, user information of said party C, and combinations thereof.

29. A computer program product comprising a computer readable storage medium retaining program instructions, which program instructions when read by a processor, cause the processor to perform a method comprising:
receiving a set of rules for implementation by a party B regarding said communication of said party B with a party C;
receiving a definition of reward given to said Party B, subject to implementation of said rules by said party B;
validating compliance in implementing said rules by said party B.

30. The product of claim 28 wherein said rules received from a party A.

31. The apparatus of claim 29, comprising verifying that said party B is a family member of at least one of said party A and said party B.
